(19) United States
(12) Patent Application Publication
(10) Pub. No.: US 2026/0071631 A1
(43) Pub. Date: Mar. 12, 2026

(54) SHUT-OFF VALVE AND VACUUM PUMP

(71) Applicant: SHIMADZU CORPORATION, Kyoto (JP)

(72) Inventor: Hiroaki KIMURA, Kyoto (JP)

(73) Assignee: SHIMADZU CORPORATION, Kyoto (JP)

(21) Appl. No.: 19/314,140

(22) Filed: Aug. 29, 2025

(30) Foreign Application Priority Data
Sep. 9, 2024 (JP) 2024-155144

(51) Int. Cl. F04D 27/00; F04D 17/16; F16K 15/02

(52) U.S. Cl. CPC F04D 27/008; F04D 17/168; F16K 15/028

(57) ABSTRACT

A shut-off valve includes a valve seat disposed between a first opening and a second opening, and a valve body disposed on the second opening side of the valve seat and configured to move in a first direction from the second opening toward the first opening due to pressure of gas flowing from the second opening toward the first opening. The valve body has a valve body shaft extending in the first direction, and a contact surface configured to contact the valve seat when the valve body moves in the first direction. The contact surface is disposed on the second opening side of a first end on the first direction side of the valve body shaft.

### [TECHNICAL FIELD]

The present invention relates to a shut-off valve and a vacuum pump.

### [BACKGROUND ART]

In fields such as semiconductor manufacturing equipment, a turbo-molecular pump, which is a type of vacuum pump, is used to create a high-vacuum atmosphere (see, for example, Patent Literature 1). In a turbo-molecular pump, a rotor is disposed within a housing, and a turbo-molecular pump section is configured in the upper part of the rotor. Rotor blades are disposed on the rotor side, and stator blades are disposed on the housing side, with the rotor blades and stator blades being alternately arranged in multiple stages with a gap of several millimeters therebetween. A drag pump section is configured in the lower part of the rotor. During pumping, the rotor rotates at a speed of tens of thousands of rpm while being magnetically levitated. The gas to be pumped flows from the space to be evacuated to an inlet port of the vacuum pump, is compressed by the turbo-molecular pump section and the drag pump section, and is discharged to the outlet port side.

If air is suddenly flowed into such a turbo-molecular pump due to a problem during operation (inrush of air), the magnetically levitated rotor comes into contact with a bearing and rapidly decelerates. This causes the bearing to wear, and repeated inrushes of air can lead to bearing failure and consequent damage to the rotor.

For this reason, Patent Literature 1 proposes a shut-off valve that prevents the inflow of air into the vacuum pump in the event of an inrush of air.

### [PRIOR ART LITERATURE]

### [PATENT LITERATURE]

[Patent Literature 1] Japanese Unexamined Patent Application Publication No. 2013-167207

### [SUMMARY OF INVENTION]

### [PROBLEM TO BE SOLVED BY THE INVENTION]

Currently, miniaturization of shut-off valves is being considered. However, it is difficult to miniaturize conventional shut-off valves. Specifically, a valve body of a shut-off valve has a contact surface that abuts a valve seat of the shut-off valve, and a shaft on which the contact surface is provided. In conventional shut-off valves, the contact surface was disposed at an end of the shaft of the valve body. For this reason, it has been difficult to miniaturize conventional shut-off valves.

An object of the present invention is to miniaturize a shut-off valve.

### [MEANS FOR SOLVING THE PROBLEM]

A shut-off valve according to one aspect of the present invention includes a valve seat and a valve body. The valve seat is disposed between a first opening and a second opening. The valve body is disposed on the second opening side of the valve seat and moves in a first direction from the second opening toward the first opening due to the pressure of gas flowing from the second opening toward the first opening. In this shut-off valve, the valve body has a valve body shaft extending in the first direction, and a contact surface that abuts the valve seat when the valve body moves in the first direction. The contact surface is disposed on the second opening side of a first end on the first direction side of the valve body shaft.

### [EFFECTS OF THE INVENTION]

According to the aspect of the present invention described above, the contact surface of the valve body that abuts the valve seat of the shut-off valve is disposed on the second opening side of the first end on the first direction side of the valve body shaft. As a result, compared to a conventional shut-off valve in which the contact surface was disposed at the end on the first direction side of the shaft, the distance between the contact surface and the end on the side opposite to the first direction side of the valve body shaft can be shortened, so the size of the housing that accommodates the valve body can be made smaller than before.

Furthermore, by disposing the contact surface of the valve body on the second opening side of the first end of the valve body shaft, the center of gravity of the valve body can be disposed closer to the center of the valve body than the first end. As a result, when the shut-off valve is arranged such that the movement direction of the valve body, which is the first direction, is a horizontal direction (a direction perpendicular to the vertical direction) or a direction close thereto, it is possible to prevent the first end of the valve body from dropping in the vertical direction, which would create resistance to the movement of the valve body in the first direction. That is, by disposing the contact surface of the valve body on the second opening side of the first end of the valve body shaft, the valve body can be moved smoothly in the first direction.

### [BRIEF DESCRIPTION OF DRAWINGS]

FIG. 1 is a diagram showing the configuration of a vacuum pump.

FIG. 2 is a cross-sectional view of a shut-off valve.

FIG. 3 is a perspective view of the shut-off valve as seen from the second opening side.

FIG. 4 is a diagram showing the shut-off valve in a state where the first opening and the second opening are spatially shut off.

FIG. 5 is a diagram showing a modified example of the valve body of the shut-off valve.

### [DESCRIPTION OF EMBODIMENTS]

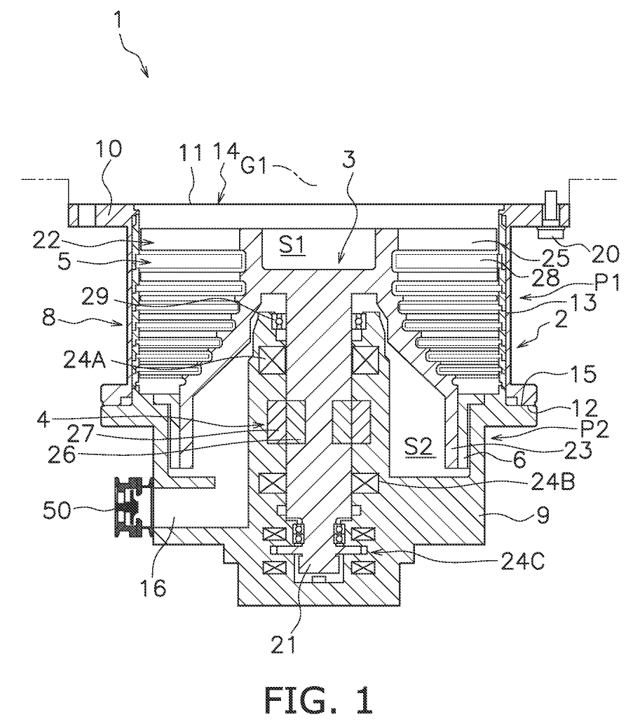

Hereinafter, a vacuum pump will be described with reference to FIG. 1. FIG. 1 is a diagram showing the configuration of a vacuum pump 1. The vacuum pump 1 has a housing 2, a rotor 3, a motor 4, a plurality of stator blade units 5, and a stator cylindrical portion 6.

The housing 2 accommodates the rotor 3, the motor 4, the plurality of stator blade units 5, and the stator cylindrical portion 6. The housing 2 has a casing 8, a base 9, and a fixed flange 10. The housing 2 is formed of a metal such as an aluminum alloy or iron. The casing 8 is a cylindrical member having the fixed flange 10 at one end.

The casing 8 accommodates the plurality of stator blade units 5 and a plurality of stages of rotor blade units 22 provided on the rotor 3. The casing 8 has a first end portion 11, a second end portion 12, and a side surface portion 13.

The first end portion 11 is attached to an apparatus to be evacuated. An inlet port 14 is provided in the first end portion 11. The second end portion 12 is located on the opposite side of the fixed flange 10 in the axial direction G1 of the rotor 3. The second end portion 12 is connected to the base 9. A first internal space S1 is formed inside the casing 8.

The base 9 is disposed so as to close an opening on the second end portion 12 side of the casing 8. The base 9 accommodates the stator cylindrical portion 6 and a rotor cylindrical portion 23 provided on the rotor 3. The base 9 has a base end portion 15 and an outlet port 16. The base end portion 15 is connected to the second end portion 12 of the casing 8. A second internal space S2 is formed inside the base 9. The second internal space S2 communicates with the first internal space S1. The outlet port 16 communicates with the second internal space S2.

The fixed flange 10 is connected to the casing 8. The fixed flange 10 protrudes from the casing 8. The fixed flange 10 is fixed to the apparatus to be evacuated by bolts 20. The term "connection" shall include the joining of members that are separate from each other. The term "connection" shall also include the linking of different parts in an integral member.

The rotor 3 has a shaft 21, a plurality of stages of rotor blade units 22, and a rotor cylindrical portion 23. The shaft 21 extends in the axial direction G1 of the rotor 3. In the following description, the direction from the casing 8 toward the base 9 in the axial direction G1 is defined as downward, and the opposite direction is defined as upward.

The vacuum pump 1 includes a protective bearing 29 and a plurality of bearings 24A to 24C. The protective bearing 29 functions as a touchdown bearing that limits radial runout of the upper side of the shaft 21. The protective bearing 29 is attached to the base 9. When the shaft 21 is in steady rotation, the shaft 21 and the protective bearing 29 are not in contact, and the shaft 21 comes into contact with the inner surface of the inner ring of the protective bearing 29 when a large disturbance is applied or when the whirling of the shaft 21 becomes large during acceleration or deceleration of rotation. A ball bearing or the like, for example, can be used for the protective bearing 29.

The plurality of bearings 24A to 24C rotatably support the rotor 3. The plurality of bearings 24A to 24C are attached to the base 9. The plurality of bearings 24A to 24C include, for example, magnetic bearings. However, the plurality of bearings 24A to 24C may include other types of bearings such as ball bearings.

The plurality of stages of rotor blade units 22 are each connected to the shaft 21. The plurality of stages of rotor blade units 22 are arranged at intervals from each other in the axial direction G1. Each rotor blade unit 22 includes a plurality of rotor blades 25. Each of the plurality of rotor blades 25 extends radially around the shaft 21. In the drawings, only one of the plurality of stages of rotor blade units 22 and one of the plurality of rotor blades 25 are given a reference numeral, and the reference numerals of the other rotor blade units 22 and other rotor blades 25 are omitted.

The rotor cylindrical portion 23 is connected to the shaft 21. The rotor cylindrical portion 23 is disposed below the rotor blade units 22. The rotor cylindrical portion 23 is cylindrical and extends in the axial direction G1. The rotor cylindrical portion 23 is disposed so as to surround the shaft 21 on the outer peripheral side of the shaft 21.

The motor 4 rotationally drives the rotor 3. As the motor 4, for example, a DC brushless motor is used. The motor 4 has a motor rotor 26 and a motor stator 27. The motor rotor 26 is attached to the shaft 21. The motor stator 27 is attached to the base 9. The motor stator 27 is disposed facing the motor rotor 26.

The plurality of stages of stator blade units 5 are connected to the inner surface of the casing 8. The plurality of stages of stator blade units 5 are arranged at intervals from each other in the axial direction G1. Each of the plurality of stages of stator blade units 5 is disposed between the plurality of stages of rotor blade units 22. Each stator blade unit 5 includes a plurality of stator blades 28. Each of the plurality of stator blades 28 extends radially around the shaft 21.

The plurality of stages of rotor blade units 22 and the plurality of stages of stator blade units 5 constitute a turbine section P1 (turbo-molecular pump). In the drawings, only one of the plurality of stator blade units 5 and one of the plurality of stator blades 28 are given a reference numeral, and the reference numerals of the other stator blade units 5 and other stator blades 28 are omitted.

The stator cylindrical portion 6 is disposed on the radially outer side of the rotor cylindrical portion 23. The stator cylindrical portion 6 is connected to the base 9. The stator cylindrical portion 6 is disposed facing the rotor cylindrical portion 23 in the radial direction of the rotor cylindrical portion 23.

A spiral screw groove is provided on the inner peripheral surface of the stator cylindrical portion 6. The rotor cylindrical portion 23 and the stator cylindrical portion 6 constitute a drag pump section P2 (screw groove pump). Note that the spiral screw groove may be provided on the outer peripheral surface of the rotor cylindrical portion 23 instead of the inner peripheral surface of the stator cylindrical portion 6.

The vacuum pump 1 described above evacuates the apparatus to be evacuated by pumping gas from the apparatus connected to the first end portion 11 of the casing 8 with the turbine section P1, and then pumping it with the drag pump section P2, and discharging it to the outside from the outlet port 16.

If a problem occurs during operation of the vacuum pump 1, air may rush into the internal space from outside the outlet port 16 of the vacuum pump 1. Such an inrush of air causes the magnetically levitated rotor 3 to contact a bearing. When the rotor 3 contacts the bearing, the bearing wears. If the inrush of air from outside the vacuum pump 1 into the internal space occurs repeatedly, the bearing will fail. If the bearing fails, the rotor 3 may be damaged. To prevent this, a shut-off valve 50 is provided at the outlet port 16 to prevent the inflow of air from the outside into the internal space of the vacuum pump 1.

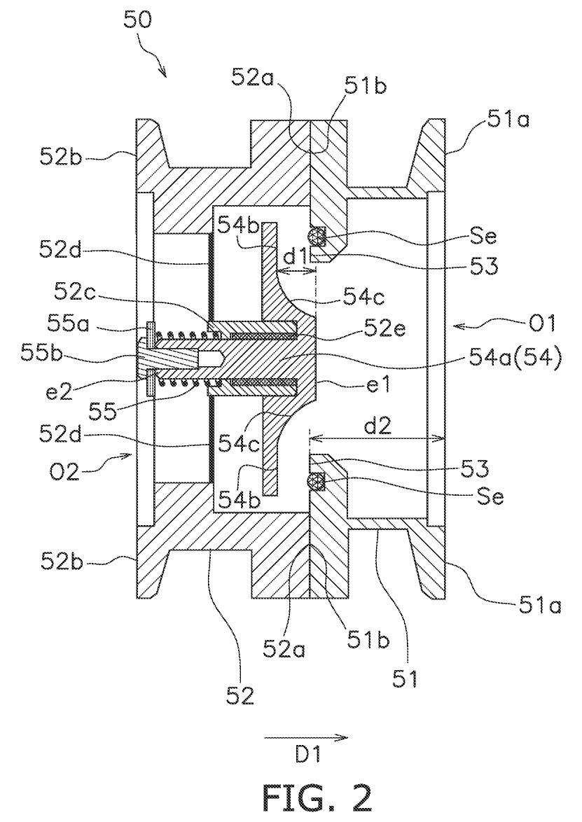

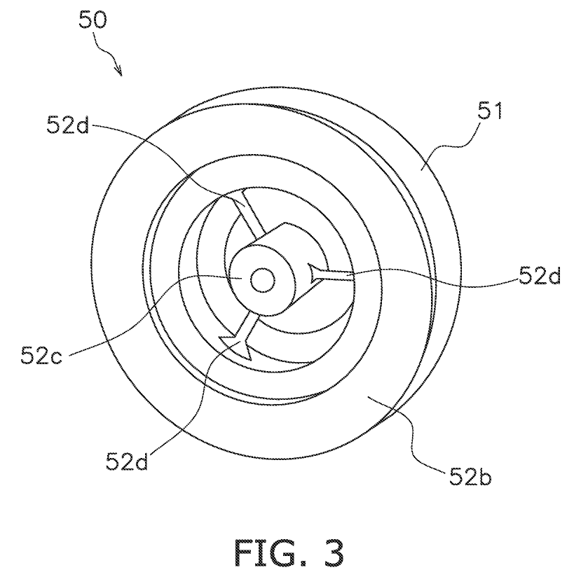

Hereinafter, the shut-off valve 50 will be specifically described with reference to FIGS. 2 and 3. FIG. 2 is a cross-sectional view of the shut-off valve 50. FIG. 3 is a perspective view of the shut-off valve 50 as seen from the second opening O2 side. The shut-off valve 50 has a first housing 51, a second housing 52, a valve seat 53, and a valve body 54.

The first housing 51 is a hollow member. The internal space of the hollow first housing 51 is a first opening O1. The first housing 51 has a first housing end portion 51a and a second housing end portion 51b. The first housing end portion 51a has a flange shape and is connected to the outlet port 16 of the vacuum pump 1. That is, the first opening O1 is connected to the outlet port 16. The second housing 52 is fixed to the second housing end portion 51b.

The second housing 52 is a hollow member. The second housing 52 has a third housing end portion 52a and a fourth housing end portion 52b. The third housing end portion 52a is fixed to the second housing end portion 51b of the first housing 51. The third housing end portion 52a is fixed to the second housing end portion 51b of the first housing 51 in an airtight manner, for example, by screwing. That is, the second housing 52 is fixed to the first housing 51 in an airtight manner, for example, by screwing.

The fourth housing end portion 52b has a flange shape and is fixed to, for example, another vacuum pump (for example, a rotary pump). The internal space on the fourth housing end portion 52b side of the hollow second housing 52 is a second opening O2. Hereinafter, the direction from the second opening O2 toward the first opening O1 of the first housing 51 will be referred to as a first direction D1.

A valve body support 52c is disposed in the internal space of the hollow second housing 52. Specifically, the valve body support 52c is disposed in the internal space of the second housing 52 by being fixed to support portions 52d extending from the inner wall of the second housing 52. Three support portions 52d are provided at equal intervals (equal angles) along the circumferential direction of the second opening O2. The number of support portions 52d provided can be arbitrary.

The valve body support 52c has a through hole extending in the first direction D1. A valve body shaft of the valve body 54 is inserted into the through hole of the valve body support 52c. A slide bearing 52e is inserted into the end portion on the first direction D1 side of the through hole of the valve body support 52c, and allows the valve body shaft of the valve body 54 to move smoothly in the first direction D1 or the opposite direction thereof. As shown in FIG. 2, since the slide bearing 52e does not protrude from the end portion on the first direction D1 side of the valve body support 52c, the valve body support 52c can be made compact.

Furthermore, by preventing the slide bearing 52e from protruding from the first direction D1 side of the valve body support 52c, when the shut-off valve 50 is in an open state (a state where the first opening and the second opening are spatially connected), the valve body 54 abuts the slide bearing 52e, thereby increasing the separation distance between the contact surface 54b and the valve seat 53 and increasing the conductance, and/or it becomes unnecessary to secure the size of the housing (the second housing 52) accommodating the valve body 54 in the first direction D1 in order to secure a large separation distance between the contact surface 54b and the valve seat 53.

A groove portion is provided at the end of the valve body support 52c on the side opposite to the first direction D1. As will be described later, a biasing member 55 is accommodated in this groove portion.

The valve seat 53 is disposed between the first opening O1 and the second opening O2 by extending from the second housing end portion 51b of the first housing 51 in the direction of the internal space of the first housing 51. A sealing member Se is provided on the valve seat 53. The sealing member Se is, for example, a rubber O-ring.

The valve body 54 has a valve body shaft 54a and a contact surface 54b. The valve body shaft 54a is a shaft extending in the first direction D1. The valve body shaft 54a is inserted into the through hole of the valve body support 52c. The valve body 54 is disposed in the internal space of the second housing 52 by the valve body shaft 54a being inserted into the through hole of the valve body support 52c. The valve body support 52c is disposed in the internal space of the second housing 52, that is, on the second opening O2 side of the valve seat 53, and the valve body shaft 54a is inserted into the through hole of this valve body support 52c, so that, as shown in FIG. 2, the valve body 54 is disposed on the second opening O2 side of the valve seat 53. The valve body shaft 54a has a first end e1 on the first direction D1 side (first opening O1 side) and a second end e2 on the side opposite to the first direction D1 (second opening O2 side).

The contact surface 54b is disposed on the second opening O2 side of the first end e1 of the valve body shaft 54a. The contact surface 54b disposed in this manner is connected to the first end e1 of the valve body shaft 54a by a connecting portion 54c. That is, the valve body shaft 54a and the contact surface 54b are connected and integrated by the connecting portion 54c. As a result, the contact surface 54b moves as the valve body shaft 54a moves in the first direction D1 or the opposite direction thereof. The contact surface 54b spatially shuts off the first opening O1 and the second opening O2 by abutting the valve seat 53 (sealing member Se) when the valve body shaft 54a moves in the first direction D1.

As shown in FIG. 2, a length d1 from the contact surface 54b to the first end e1 of the valve body shaft 54a is shorter than a length d2 from the valve seat 53 to the first housing end portion 51a of the first housing 51 (that is, the length of the first opening O1 in the first direction D1). As a result, when the contact surface 54b abuts the valve seat 53, the valve body shaft 54a does not protrude from the first opening O1. A member such as a filter may be provided at the outlet port 16 of the vacuum pump 1, but by preventing the valve body shaft 54a from protruding from the first opening O1, it is possible to prevent the valve body shaft 54a from damaging the member provided at the outlet port 16.

The connecting portion 54c that connects the valve body shaft 54a and the contact surface 54b has a tapered shape or a curved shape. As a result, when the first opening O1 and the second opening O2 are spatially connected and gas is pumped from the outlet port 16 of the vacuum pump 1 to the outside (the vacuum pump connected to the fourth housing end portion 52b), the conductance for the gas flow from the first opening O1 to the second opening O2 can be increased. As a result, the vacuum pump 1 can be efficiently evacuated.

The shut-off valve 50 has a biasing member 55. The end portion on the first opening O1 side of the biasing member 55 is inserted into a groove portion formed on the second opening O2 side of the valve body support 52c. A lid member 55a is disposed at the end portion on the second opening O2 side of the biasing member 55 and is fixed to the second end e2 of the valve body shaft 54a by a screw 55b. As a result, the biasing member 55 is fixed between the valve body support 52c and the lid member 55a, and can bias the valve body 54 (its valve body shaft 54a) in the direction opposite to the first direction D1. The biasing member 55 is, for example, a spring member. The biasing force of the biasing member 55 can be appropriately determined, for example, based on the extent of the reverse flow rate of air and the pressure difference required to spatially shut off the first opening O1 and the second opening O2.

By providing the biasing member 55 in the shut-off valve 50, the valve body 54 abuts the end portion on the first direction D1 side of the valve body support 52c in a normal state (a state where there is no gas flow in the first direction D1), and does not cause the contact surface 54b to abut the valve seat 53. That is, in the normal state, the valve body 54 spatially connects the first opening O1 and the second opening O2.

Hereinafter, the operation of the shut-off valve 50 will be described. When the vacuum pump 1 is driven to evacuate the apparatus to be evacuated, gas flows from the first opening O1 to the second opening O2 (that is, in a normal state), so the valve body 54 moves to the side opposite to the first direction D1 by the biasing force of the biasing member 55 and abuts the end portion on the first direction D1 side of the valve body support 52c. As a result, the contact surface 54b of the valve body 54 is separated from the valve seat 53, and spatially connects the first opening O1 and the second opening O2.

If an inrush of air occurs on the second opening O2 side of the shut-off valve 50 due to a failure of the vacuum pump 1 or the like, air flows backward in the first direction D1 of the shut-off valve 50, and the valve body 54 (for example, the portion where the contact surface 54b of the valve body 54 is formed, the lid member 55a, etc.) receives the pressure of the air.

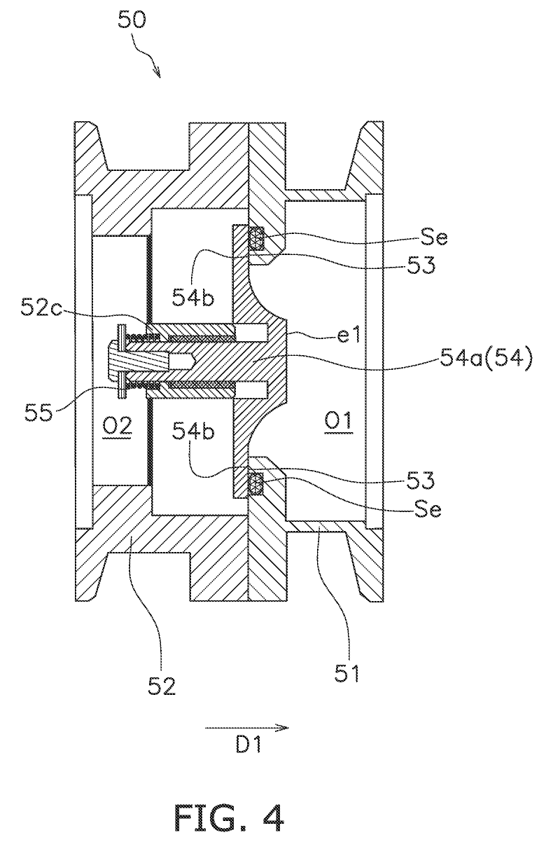

When the pressure received by the valve body 54 exceeds the biasing force of the biasing member 55, the valve body 54 moves in the first direction D1. When the valve body 54 moves in the first direction D1, the contact surface 54b of the valve body 54 abuts the valve seat 53 as shown in FIG. 4, and the first opening O1 and the second opening O2 are spatially shut off. By spatially shutting off the first opening O1 and the second opening O2, the backflow of air in the first direction D1 is prevented. As a result, the inflow of air into the vacuum pump 1 can be prevented. FIG. 4 is a diagram showing the shut-off valve 50 in a state where the first opening O1 and the second opening O2 are spatially shut off.

As described above, in the shut-off valve 50 of the present embodiment, the contact surface 54b of the valve body 54 that abuts the valve seat 53 of the shut-off valve 50 is disposed on the second opening O2 side of the first end e1 on the first direction D1 side of the valve body shaft 54a. As a result, compared to a conventional shut-off valve in which the contact surface was disposed at the end on the first direction side of the shaft, the distance between the contact surface 54b and the second end e2 on the side opposite to the first direction D1 side of the valve body shaft 54a can be shortened, so the size of the housing (mainly the second housing 52) that accommodates the valve body 54 can be made smaller than before, and the shut-off valve 50 can be miniaturized.

Furthermore, by disposing the contact surface 54b of the valve body 54 on the second opening O2 side of the first end e1 of the valve body shaft 54a, the center of gravity of the valve body 54 can be disposed closer to the center of the valve body 54 than the first end e1. As a result, as shown in FIG. 2 and the like, when the shut-off valve 50 is arranged such that the movement direction of the valve body 54, which is the first direction D1, is a horizontal direction or a direction close thereto, it is possible to prevent the first end e1 of the valve body shaft 54a of the valve body 54 from dropping in the vertical direction, which would create resistance to the movement of the valve body 54 in the first direction D1 or the opposite direction thereof. That is, by disposing the contact surface 54b of the valve body 54 on the second opening O2 side of the first end e1 of the valve body shaft 54a, the valve body 54 can be moved smoothly in the first direction D1 or the opposite direction thereof.

If the contact surface 54b is disposed on the second opening O2 side of the first end e1 of the valve body 54, when the valve body 54 moves in the first direction D1 and the contact surface 54b abuts the valve seat 53, the first end e1 is disposed at a position on the first opening O1 side of the valve seat 53, as shown in FIG. 4. If the contact surface is disposed at the first end as in a conventional shut-off valve, even if the valve body shaft of the valve body is shortened for miniaturization, the separation distance between the contact surface and the valve seat when the shut-off valve is in the open state becomes small, and the conductance becomes small. That is, it becomes difficult to efficiently evacuate the vacuum pump 1. In other words, by disposing the contact surface 54b on the second opening O2 side of the first end e1 of the valve body 54, the separation distance between the contact surface 54b and the valve seat 53 when the shut-off valve 50 is in the open state can be increased, and the conductance can be increased. That is, while miniaturizing the shut-off valve 50, the vacuum pump 1 can be efficiently evacuated.

Furthermore, if the contact surface is disposed at the first end as in a conventional shut-off valve, even if the valve body shaft of the valve body is shortened for miniaturization, it is necessary to enlarge the housing that accommodates the valve body in order to secure the separation distance between the contact surface and the valve seat when the shut-off valve is in the open state. That is, by disposing the contact surface 54b on the second opening O2 side of the first end e1 of the valve body 54, while miniaturizing the housing (especially the second housing 52) that accommodates the valve body 54, a large separation distance between the contact surface 54b and the valve seat 53 when the shut-off valve 50 is in the open state can be secured, and the conductance can be increased.

By miniaturizing the shut-off valve 50 to be provided at the outlet port 16 of the vacuum pump 1, particularly in the direction from the first opening O1 connected to the outlet port 16 toward the second opening O2 connected to other piping, etc., when providing the shut-off valve 50 to the vacuum pump 1 included in an existing vacuum system, design changes to the piping, etc. of the vacuum system can be made unnecessary or minimized. For example, if the shut-off valve is large in the first direction, it is necessary to shorten the piping that was connected to the vacuum pump by cutting or replacing it, or to change the installation position of the vacuum pump. Not only that, but the adjustment of the length of the piping connected to the vacuum pump and the change in the installation position of the vacuum pump may affect other piping, and it may be necessary to change the design of the entire piping of the vacuum system.

On the other hand, by making the shut-off valve 50 provided at the outlet port 16 of the vacuum pump 1 compact, particularly in the first direction D1 from the first opening O1 connected to the outlet port 16 toward the second opening O2 connected to other piping, etc., for example, the shut-off valve 50 can be attached to the outlet port 16 of the vacuum pump 1 by slightly moving the piping connected to the vacuum pump 1 and/or the vacuum pump 1.

Although one embodiment of the present invention has been described above, the present invention is not limited to the above-described embodiment, and various changes can be made without departing from the gist of the invention.

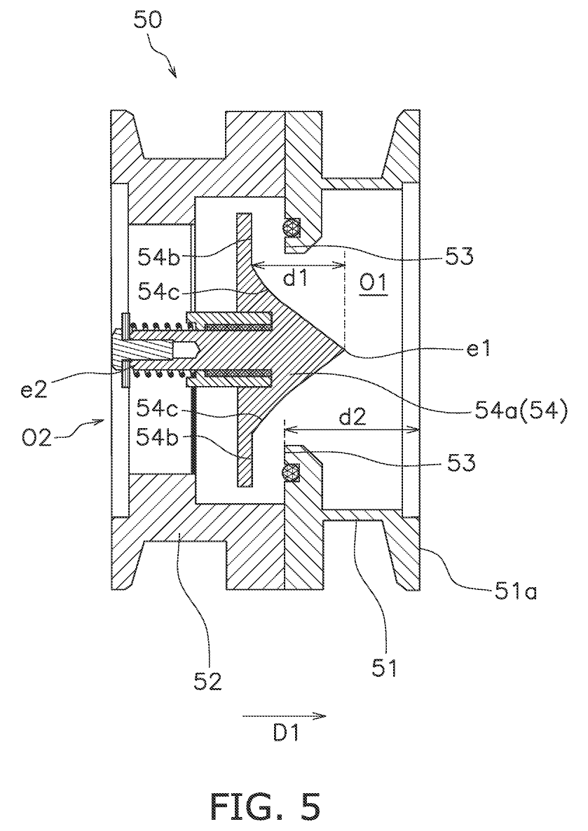

As shown in FIG. 5, the first end e1 of the valve body shaft 54a of the valve body 54 may have, for example, a conical shape such as a cone shape whose apex is on the first opening O1 side. As a result, compared to the case where the first end e1 is a flat surface, the resistance of the first end e1 to the gas flow can be reduced. As a result, the viscous flow of gas can be further improved. FIG. 5 is a diagram showing a modified example of the valve body 54 of the shut-off valve 50.

Note that even when the first end e1 has a conical shape, it is preferable that the length d1 from the contact surface 54b to the first end e1 is shorter than the length d2 of the first opening O1 in the first direction D1 (the length from the valve seat 53 to the first housing end portion 51a of the first housing 51). As a result, the first end e1 (the apex of the conical shape) can be prevented from protruding from the first opening O1.

The shut-off valve 50 described above can be used for purposes other than preventing an inrush of air into the vacuum pump 1. For example, it can be used for the purpose of preventing the backflow of gas by inserting it into various gas pipes. The biasing force of the biasing member 55 can be appropriately determined according to various applications.

Those skilled in the art will understand that the plurality of exemplary embodiments described above are specific examples of the following aspects.

(First Aspect) A shut-off valve (for example, shut-off valve 50) includes a valve seat (for example, valve seat 53) and a valve body (for example, valve body 54). The valve seat 53 is disposed between a first opening (for example, first opening O1) and a second opening (for example, second opening O2). The valve body is disposed on the second opening side of the valve seat and moves in a first direction (for example, first direction D1) from the second opening toward the first opening due to the pressure of gas flowing from the second opening toward the first opening. In this shut-off valve, the valve body has a valve body shaft (for example, valve body shaft 54a) extending in the first direction, and a contact surface (for example, contact surface 54b) that abuts the valve seat when the valve body moves in the first direction. The contact surface is disposed on the second opening side of a first end (for example, first end e1) on the first direction side of the valve body shaft.

In the shut-off valve according to the first aspect, the contact surface of the valve body that abuts the valve seat of the shut-off valve is disposed on the second opening side of the first end on the first direction side of the valve body shaft. As a result, compared to a conventional shut-off valve in which the contact surface was disposed at the end on the first direction side of the shaft, the distance between the contact surface and the end on the side opposite to the first direction side of the valve body shaft can be shortened, so the size of the housing that accommodates the valve body can be made smaller than before.

Furthermore, by disposing the contact surface of the valve body on the second opening side of the first end of the valve body shaft, the center of gravity of the valve body can be disposed closer to the center of the valve body than the first end. As a result, when the shut-off valve is arranged such that the movement direction of the valve body, which is the first direction, is a horizontal direction (a direction perpendicular to the vertical direction) or a direction close thereto, it is possible to prevent the first end of the valve body from dropping in the vertical direction, which would create resistance to the movement of the valve body in the first direction. That is, by disposing the contact surface of the valve body on the second opening side of the first end of the valve body shaft, the valve body can be moved smoothly in the first direction.

(Second Aspect) In the shut-off valve according to the first aspect, the valve body may have a connecting portion of a tapered shape or a curved shape (for example, connecting portion 54c) that connects the contact surface and the first end. In the shut-off valve according to the second aspect, the first opening and the second opening are spatially connected, and when gas flows from the first opening toward the second opening, the conductance for the gas flow from the first opening to the second opening can be increased.

(Third Aspect) In the shut-off valve according to the first aspect or the second aspect, the first end may have a conical shape. In the shut-off valve according to the third aspect, the resistance of the first end of the valve body shaft to gas flow can be reduced.

(Fourth Aspect) In the shut-off valve according to any one of the first to third aspects, a length (for example, length d1) from the contact surface to the first end may be shorter than a length (for example, length d2) of the first opening in the first direction. In the shut-off valve according to the fourth aspect, since the valve body shaft does not protrude from the first opening when the contact surface abuts the valve seat, it is possible to prevent the valve body shaft 54a from damaging a member provided in the vicinity of the first opening.

(Fifth Aspect) A vacuum pump (for example, vacuum pump 1) includes the shut-off valve according to any one of the first to fourth aspects, and an outlet port (for example, outlet port 16) connected to the first opening of the shut-off valve. In the vacuum pump according to the fifth aspect, the shut-off valve provided at the outlet port of the vacuum pump is miniaturized in the direction from the first opening connected to the outlet port toward the opposite second opening. In the vacuum pump according to the fifth aspect, when providing the shut-off valve to an existing vacuum system including the vacuum pump, design changes to the piping, etc. of the vacuum system can be made unnecessary or minimized.

### [REFERENCE SIGNS LIST]

1: Vacuum pump

2: Housing

3: Rotor

4: Motor

5: Stator blade unit

6: Stator cylindrical portion

8: Casing

9: Base

10: Fixed flange

11: First end portion

12: Second end portion

13: Side surface portion

14: Inlet port

15: Base end portion

16: Outlet port

20: Bolt

21: Shaft

22: Rotor blade unit

23: Rotor cylindrical portion

24A-24C: Bearing

25: Rotor blade

26: Motor rotor

27: Motor stator

28: Stator blade

29: Protective bearing

P1: Turbine section

P2: Drag pump section

S1: First internal space

S2: Second internal space

50: Shut-off valve

51: First housing

51a: First housing end portion

51b: Second housing end portion

O1: First opening

52: Second housing

52a: Third housing end portion

52b: Fourth housing end portion

52c: Valve body support

52d: Support portion

52e: Slide bearing

O2: Second opening

53: Valve seat

Se: Sealing member

54: Valve body

54a: Valve body shaft

e1: First end

e2: Second end

54b: Contact surface

54c: Connecting portion

55: Biasing member

55a: Lid member

55b: Screw

D1: First direction

1. A shut-off valve, comprising:
a valve seat disposed between a first opening and a second opening; and
a valve body disposed on the second opening side of the valve seat and configured to move in a first direction from the second opening toward the first opening due to pressure of gas flowing from the second opening toward the first opening,
wherein the valve body has:
a valve body shaft extending in the first direction, and
a contact surface configured to contact the valve seat when the valve body moves in the first direction, and
the contact surface is disposed on the second opening side of a first end on the first direction side of the valve body shaft.

2. The shut-off valve according to claim 1, wherein the valve body has a connecting portion of a tapered shape or a curved shape that connects the contact surface and the first end.

3. The shut-off valve according to claim 1, wherein the first end has a conical shape.

4. The shut-off valve according to claim 1, wherein a length from the contact surface to the first end is shorter than a length of the first opening in the first direction.

5. A vacuum pump, comprising:
the shut-off valve according to claim 1; and
an outlet port connected to the first opening of the shut-off valve.
